(19) United States
(12) Patent Application Publication
(10) Pub. No.: US 2011/0120346 A1
(43) Pub. Date: May 26, 2011

(54) AQUEOUS UNIVERSAL PIGMENT PASTE

(75) Inventors: Hans Ulrich Reisacher, Maxdorf (DE); Uwe Mauthe, Mannheim (DE)

(73) Assignee: BASF SE, Ludwigshafen (DE)

(21) Appl. No.: 13/056,363

(22) PCT Filed: Jul. 27, 2009
(86) PCT No.: PCT/EP2009/059669

§ 371 Date: Jan. 28, 2011

(30) Foreign Application Priority Data
Jul. 29, 2008 (EP) 08161328.3

(51) Int. Cl. C04B 16/00

(52) U.S. Cl. 106/499

(57) ABSTRACT

The present invention relates to aqueous pigment compositions comprising—based in each case on the total weight of the composition—
(A) 10% to 70% by weight of a coloring component comprising at least one color pigment and if appropriate at least one filler;
(B) 0.1% to 30% by weight of a surface-active additive component based on at least one phosphoric or phosphonic ester, which may be anionic or nonionic;
(C) 0.1% to 10% by weight of a nonionic, surface-active additive component based on at least one hydroxyl-containing acetylene or acetylene alkoxylate;
(D) 0% to 20% by weight of an additive component comprising additives different than (B) and (C);
(E) 1% to 89.8% by weight of a solvent component at least comprising water.

The invention further relates to processes for preparing them and also to their use.

The present invention relates to an aqueous pigment composition, its preparation and use.

Pigment preparations are frequently used in order to pigment liquid systems such as paint products, varnishes, emulsion paints, and printing inks.

In these applications it is advantageous if the aqueous pigment composition can be used as far as possible universally in relation to the liquid system. This requires, in particular, the possibility for suspension in paints with both aqueous and organic solvents forming the bases of the liquid systems. In the case of the organic solvents, differentiation is required, in addition, as to whether they are substantially aromatic or aliphatic in nature.

In this context it is important in particular that the pigment compositions have a very low fraction of volatile organic compounds, to allow aqueous paints as well to be produced with very low VOC contents.

Universal colorant compositions are described for example in WO-A 2006/102 011.

Universal preparations based on alkylpolyglycosides are disclosed in U.S. Pat. No. 5,340,394.

Universal pigment preparations comprising polyalkylene oxides and unhydrogenated ketone-aldehyde resins are described in DE-A 10 2006 026759.

A composition comprising pigment plus a resin soluble both in water and in organic solvents is described in WO-A 03/057783.

Further pigment dispersions which can be used universally are described in U.S. Pat. No. 5,934,513, U.S. Pat. No. 6,287,377, and U.S. Pat. No. 6,488,760.

In spite of the universal compositions known from the prior art there continues to be a need for alternative compositions which are suitable by virtue in particular of their flowability and pumpability, coloristic properties, and viscosity, particularly after incorporation into liquid systems such as paints or wood stains, and in particular for aqueous and organic, such as aromatic and aliphatic, liquid systems.

It is an object of the present specification, therefore, to provide such compositions. This object is achieved by means of an aqueous pigment composition comprising—based in each case on the total weight of the composition—
(A) 10% to 70% by weight of a coloring component comprising at least one color pigment and if appropriate at least one filler;
(B) 0.1% to 30% by weight of a surface-active additive component based on at least one phosphoric or phosphonic ester, which may be anionic or nonionic;
(C) 0.1% to 10% by weight of a nonionic, surface-active additive component based on at least one hydroxyl-containing acetylene or acetylene alkoxylate;
(D) 0% to 20% by weight of an additive component comprising additives different than (B) and (C);
(E) 1% to 89.8% by weight of a solvent component at least comprising water.

It has emerged that aqueous pigment compositions in the present invention, by virtue in particular of components (B) and (C), represent universally suitable pigment compositions which can be incorporated in particular into aqueous and nonaqueous systems.

Component (A) of the aqueous pigment composition of the invention comprises at least one pigment. Component (A) may further comprise at least one filler as well. Fillers are frequently used in compositions with relatively low pigment contents in order to adjust storage stabilities and viscosities. It will be appreciated that two or more pigments and/or two or more different fillers may be present in component (A).

Component A preferably comprises 5% to 100% by weight, based on component A, of at least one pigment (A1) and 0% to 95% by weight, based on component A, of at least one filler (A2) which has no inherent color.

The fraction (A1), relative to component (A), is preferably 10% to 100% by weight.

The fraction of component (A), relative to the total weight of the aqueous pigment composition of the invention, is 10% to 70% by weight. Preferably this fraction is 10% to 60% by weight.

The pigment(s) present may comprise organic or inorganic pigments. It will be appreciated that the coloring component may also comprise mixtures of different inorganic pigments or different organic pigments, or mixtures of organic and inorganic pigments.

The pigments are typically in finely divided form. The pigments, accordingly, typically have average particle sizes of 0.01 to 5 μm.

Inorganic pigments used may be chromatic, black, and white pigments (color pigments) and also luster pigments. Typical organic pigments are chromatic pigments and black pigments.

Examples of suitable organic pigments are as follows:
monoazo pigments: C.I. Pigment Brown 25;
   C.I. Pigment Orange 5, 13, 36, 38, 64, and 67;
   C.I. Pigment Red 1, 2, 3, 4, 5, 8, 9, 12, 17, 22, 23, 31, 48:1, 48:2, 48:3, 48:4, 49, 49:1, 51:1, 52:1, 52:2, 53, 53:1, 53:3, 57:1, 58:2, 58:4, 63, 112, 146, 148, 170, 175, 184, 185, 187, 191:1, 208, 210, 245, 247, and 251;
   C.I. Pigment Yellow 1, 3, 62, 65, 73, 74, 97, 120, 151, 154, 168, 181, 183, and 191;
   C.I. Pigment Violet 32;
disazo pigments: C.I. Pigment Orange 16, 34, 44, and 72;
   C.I. Pigment Yellow 12, 13, 14, 16, 17, 81, 83, 106, 113, 126, 127, 155, 174, 176, 180, and 188;
disazo condensation pigments: C.I. Pigment Yellow 93, 95, and 128;
   C.I. Pigment Red 144, 166, 214, 220, 221, 242, and 262;
   C.I. Pigment Brown 23 and 41;
anthanthrone pigments: C.I. Pigment Red 168;
anthraquinone pigments: C.I. Pigment Yellow 147, 177, and 199;
   C.I. Pigment Violet 31;
anthrapyrimidine pigments: C.I. Pigment Yellow 108;
quinacridone pigments: C.I. Pigment Orange 48 and 49;
   C.I. Pigment Red 122, 202, 206, and 209;
   C.I. Pigment Violet 19;
quinophthalone pigments: C.I. Pigment Yellow 138;
diketopyrrolopyrrole pigments: C.I. Pigment Orange 71, 73, and 81;
   C.I. Pigment Red 254, 255, 264, 270, and 272;
dioxazine pigments: C.I. Pigment Violet 23 and 37;
   C.I. Pigment Blue 80;
flavanthrone pigments: C.I. Pigment Yellow 24;
indanthrone pigments: C.I. Pigment Blue 60 and 64;
isoindoline pigments: C.I. Pigments Orange 61 and 69;
   C.I. Pigment Red 260;
   C.I. Pigment Yellow 139 and 185;
isoindolinone pigments: C.I. Pigment Yellow 109, 110, and 173;
isoviolanthrone pigments: C.I. Pigment Violet 31;
metal complex pigments: C.I. Pigment Red 257;
   C.I. Pigment Yellow 117, 129, 150, 153, and 177;
   C.I. Pigment Green 8;
perinone pigments: C.I. Pigment Orange 43;
   C.I. Pigment Red 194;
   perylene pigments: C.I. Pigment Black 31 and 32;
   C.I. Pigment Red 123, 149, 178, 179, 190, and 224;
   C.I. Pigment Violet 29;
phthalocyanine pigments: C.I. Pigment Blue 15, 15:1, 15:2, 15:3, 15:4, 15:6, and 16;
   C.I. Pigment Green 7 and 36;
pyranthrone pigments: C.I. Pigment Orange 51;
   C.I. Pigment Red 216;
pyrazoloquinazolone pigments: C.I. Pigment Orange 67;
   C.I. Pigment Red 251;
thioindigo pigments: al. Pigment Red 88 and 181;
   C.I. Pigment Violet 38;
triarylcarbonium pigments: C.I. Pigment Blue 1, 61, and 62;
   C.I. Pigment Green 1;
   C.I. Pigment Red 81, 81:1, and 169;
   C.I. Pigment Violet 1, 2, 3, and 27;
C.I. Pigment Black 1 (aniline black);
C.I. Pigment Yellow 101 (aldazine yellow);
C.I. Pigment Brown 22.

Examples of suitable inorganic pigments are as follows
white pigments: titanium dioxide (C.I. Pigment White 6), zinc white, pigment-grade zinc oxide; zinc sulfide, lithopones;
black pigments: black iron oxide (C.I. Pigment Black 11), iron manganese black, spinel black (C.I. Pigment Black 27); carbon black (C.I. Pigment Black 7);
chromatic pigments: chromium oxide, chromium oxide hydrate green; chromium green (C.I. Pigment Green 48); cobalt green (C.I. Pigment Green 50); ultramarine green;
   cobalt blue (C.I. Pigment Blue 28 and 36; C.I. Pigment Blue 72); ultramarine blue; manganese blue;
   ultramarine violet; cobalt violet and manganese violet;
   red iron oxide (C.I. Pigment Red 101); cadmium sulfoselenide (C.I. Pigment Red 108); cerium sulfide (C.I. Pigment Red 265);
   molybdate red (C.I. Pigment Red 104); ultramarine red;
   brown iron oxide (C.I. Pigment Brown 6 and 7), mixed brown, spinel phases and corundum phases (C.I. Pigment Brown 29, 31, 33, 34, 35, 37, 39, and 40), chromium titanium yellow (C.I. Pigment Brown 24), chromium orange;
   cerium sulfide (C.I. Pigment Orange 75);
   yellow iron oxide (C.I. Pigment Yellow 42); nickel titanium yellow (C.I. Pigment Yellow 53; C.I. Pigment Yellow 157, 158, 159, 160, 161, 162, 163, 164, and 189); chromium titanium yellow; spinet phases (C.I. Pigment Yellow 119); cadmium sulfide and cadmium zinc sulfide (C.I. Pigment Yellow 37 and 35); chromium yellow (C.I. Pigment Yellow 34); bismuth vanadate (C.I. Pigment Yellow 184).

The luster pigments are platelet-shaped pigments having a monophasic or polyphasic construction, whose color play is marked by the interplay of interference, reflection, and absorption phenomena. Examples include aluminum flakes and aluminum, iron oxide, and mica flakes each bearing one or more coats, especially of metal oxides.

The coloring component may further comprise at least one filler (A2).

Said at least one filler is preferably a colorless or white filler.

These colorless or white fillers generally have a refractive index ≦1.7. For example, the refractive index of chalk is 1.55, of barytes 1.64, of kaolin 1.56, of talc 1.57, of mica 1.58, and of silicates 1.55.

The fillers are typically insoluble in the application medium and derive in particular from the following chemical classes, with both products of natural origin and products of synthetic origin being listed by way of example:
oxides and hydroxides:
natural: alumina and magnesium oxide;
synthetic: aluminum hydroxide and magnesium hydroxide;
silicon dioxide and silicates:
natural: quartz, christobalite, kieselguhr, talc, kaolin, siliceous earth, mica, wolastonite, and feldspar;
synthetic: fumed silica, precipitated silica, aluminosilicates, and calcined aluminosilicates;
carbonates:
natural: calcium carbonates and magnesium carbonates, such as calcite, chalk, dolomite, and magnesite;
synthetic: precipitated calcium carbonate;
sulfates:
natural: barium sulfates and calcium sulfates, such as barytes and gypsum;
synthetic: precipitated barium sulfate.

The fillers may have any of a wide variety of particle shapes. They may for example be spheres, cubes, platelets or fibers. Natural-based fillers typically have particle sizes in the range from about 1 to 300 μm. Thus, commercial products based on natural chalk, for example, have a d₅₀ value of in general 1 to 160 μm. Particle sizes below 1 μm are generally present only in the case of fillers produced synthetically, in particular by precipitation methods.

Preferred fillers are carbonates and sulfates, particular preference being given to natural and precipitated chalk and also barium sulfate. These products are available commercially, for example, under the names Omyacarb® and Omyalite® (from Omya) and Blanc fixe (from Sachtleben). Further preferred fillers are natural silicates such as kaolin and talc under the name Finntalc® (from Mondo Minerals Oy).

Component (A) preferably comprises at least one inorganic pigment, such as transparent iron oxide pigment or carbon black, for example.

The pigment derivatives cited below are especially suitable as pigment synergists, which may form the pigment system (A1) together with one or more pigments, especially organic pigments.

In one preferred embodiment, component (A), besides at least one pigment, further comprises at least one pigment synergist. The proportion of said synergist as a fraction of the total weight of the composition of the invention is preferably 0.01% to 2% by weight, more preferably 0.1% to 1% by weight.

The synergists in question are pigment derivatives of the formula I

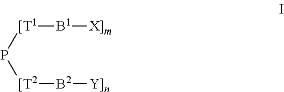

in which the variables have the following definitions:
P is the residue of the core structure of an organic pigment;
T1 and T2 each independently are a chemical bond, —CONR1- or —SO2NR1-;
B1 and B2 each independently are a chemical bond, C1-C8-alkylene or phenylene;
X and Y each independently are alike or different groups, —SO3-Ka+ or —COO— Ka+;
m and n are each a rational number from 0 to 3, subject to the proviso that 1≦m+n≦4;
Ka+ is H+, Li+, Na+, K+, N+R2R3R4R5 or a mixture of these cations;
R1 is hydrogen; C1-C4-alkyl; phenyl or naphthyl, each of which may be substituted by C1-C18-alkyl;
R2, R3, R4, and R5 are each independently hydrogen; C1-C30-alkyl; C3-C30-alkenyl; C5-C6-cycloalkyl, which may be substituted by C1-C24-alkyl; phenyl or naphthyl, each of which may be substituted by C1-C24-alkyl or C2-C24-alkenyl; a radical of the formula —[CHR6-CHR7-O]x-R8, where for x>1 the repeat units —[CHR6-CHR7-O] may vary;
R6, R7 and R8 are each independently hydrogen or C1-C6-alkyl;
x is an integer ≧1.

The pigment derivatives I are based on the core structure P of an organic pigment, functionalized by sulfonic and/or carboxylic acid groups, which are attached to the core structure either directly or via bridges. The term “core structure” as used herein is intended to comprehend the pigments themselves and also their precursors. Pigment precursors come into consideration in the case of polycyclic pigments in particular. They have the ring structure of the pigment, but the complete substitution pattern of the pigment is absent and/or functionalizations are missing. As an example, perylene-3,4-dicarboximides are precursors of the perylene pigments based on perylene-3,4,9,10-tetracarboxylic acids and their diimides.

Preferred in principle for the pigment derivatives I are the core structures of pigments from the series of the anthraquinone, quinacridone, quinophthalone, diketopyrrolopyrrole, dioxazine, flavanthrone, indanthrone, isoindoline, isoindolinone, isoviolanthrone, perinone, perylene, phthalocyanine, pyranthrone, pyrazoloquinazolone, and thioindigo pigments. On account of their broad usefulness, pigment core structures from the series of the quinophthalone, perylene, and phthalocyanine pigments are particularly preferred in this context. Especially preferred among these, in turn, are the core structures from the series of the quinophthalone pigments and phthalocyanine pigments. The quinophthalone-based pigment derivatives I (especially the pigment derivative Ia) identified in more detail below) are especially suitable for combination with yellow, orange, and red pigments, the phthalocyanine-based pigment derivatives I (especially the pigment derivative Ib likewise identified in more detail below) are especially suitable for combination with blue, green, violet, and black pigments.

The pigment derivatives I preferably comprise the sulfonic and/or carboxylic acid groups X and Y, respectively, attached directly to the pigment core structure P, i.e., T¹ and B¹ and also T² and B² are all preferably a chemical bond.

T¹ and T² may, however, also be bridges of the formula —CONR¹— or —SO₂NR¹— (R¹: hydrogen; C₁-C₄-alkyl; naphthyl or, in particular, phenyl, each of which may be substituted by C₁-C₁₅-alkyl, but is preferably unsubstituted). Examples of particularly suitable bridges T¹ and T² are —CONH—, SO₂NH—, —CON(CH₃)—, and —SO₂N(CH₃)—.

Similarly it is possible for B¹ and B² to be unbranched or branched C₁-C₈-alkylene radicals or phenylene radicals. Examples include the following: methylene, 1,1- and 1,2-ethylene, 1,1-, 1,2- and 1,3-propylene, and 1,4-, 1,3-, and 1,2-phenylene.

Suitable combinations of the bridges T and B are, for example, —CONH—CH₂—, —CON(CH₃)—CH₂—, —CONH—C₂H₄—, —CONH—CH(CH₃)—, —SO₂NH—CH₂—, —SO₂N(CH₃)—CH₂—, —SO₂NH—C₂H₄—, —SO₂NH—CH(CH₃)—, —CONH-1,4-C₆H₄, and —SO₂NH-1,4-C₆H₄—.

The sulfonic and/or carboxylic acid groups X and Y, respectively, may be present as a free acid or as a salt (Ka⁺:Li⁺, Na⁺, K⁺ or N⁺R²R³R⁴R⁵).

The ammonium salts in this context may be formed of unsubstituted ammonium ions, but preferably at least one of radicals R², R³, R⁴, and R⁵ is different than hydrogen.

Suitable aliphatic radicals R², R³, R⁴, and R⁵ are C₁-C₃₀-alkyl and C₃-C₃₀-alkenyl radicals, which may be unbranched or branched, and C₅-C₆-cycloalkyl radicals which may be substituted by C₁-C₂₄-alkyl, preferably C₁-C₁₅-alkyl. Suitable aromatic radicals include phenyl and naphthyl, each of which may be substituted by C₁-C₂₄-alkyl or by C₂-C₂₄-alkenyl, especially C₁-C₁₈-alkyl or C₂-C₁₈-alkenyl. Furthermore, the radicals R², R³, R⁴, and R⁵ may also be polyalkyleneoxy radicals of the formula —[CHR⁶—CHR⁷—O]ₓ—R⁸ (R⁶, R⁷, and R⁸: each independently hydrogen, C₁-C₆-alkyl; x≧1). If x is >1, they may be homopolymeric radicals, in other words, for example, pure polyethyleneoxy or pure polypropyleneoxy radicals, or may be copolymeric radicals comprising different alkyleneoxy units, in particular blockwise or else randomly, e.g., polyethyleneoxy/polypropyleneoxy radicals.

Preference is give to the aromatic and particular preference to the noncyclic aliphatic radicals R², R³, R⁴, and R⁵.

Especially suitable ammonium salts are mono-C₈-C₃₀-alkyl- or -alkenyl ammonium salts, examples being lauryl-, stearyl-, oleyl-, and tallowalkyl-ammonium salts, and also quaternized ammonium salts, comprising a total of 24 to 42 C atoms, where at least one, preferably two, of the alkyl and/or alkenyl radicals has/have at least 8, preferably 12, more preferably 12 to 20 C atoms, e.g., dimethyldidodecyl-, dimethyldioleyl-, and dimethyldistearyl-ammonium salts.

In the pigment derivatives I the sulfonic and/or carboxylic acid groups X and Y, respectively, are preferably not in free form. When they have not already been converted to the salt, the formation of the salt, and especially the formation of the sodium salt, is accomplished in general during the preparation of the pigment composition, which in that case preferably comprises a neutralizing step. Where salt formation has not taken place or is incomplete, and where a nonionic surface-active additive is used that has a basic center, a nitrogen atom for example, the acid groups can of course also react with this additive to form salts.

In many cases, therefore, mixtures of different salts will be present. When this is the case, the preferred sodium and/or ammonium salts (especially the ammonium salts explicitly cited above) ought at least to constitute a high proportion of these mixtures.

The pigment derivatives I may comprise 1 to 4 acid groups. Depending on the pigment core structure P, in the case of a phthalocyanine radical P, for example, the pigment derivatives I may represent statistical mixtures of molecules having different degrees of substitution, and so the mean value of the sum m+n may be a fractional number.

The pigment derivatives I preferably comprise sulfonic acid groups exclusively. In that case a degree of substitution (m+n) of 1 to 3, especially 1 to 2, has proven especially advantageous. Where the sulfonic acid groups are present in the form of an ammonium salt (m) and, if appropriate, sodium salt, or in the form of the free acid (n), m is preferably 1 to 1.8 and n is 0 to 0.2.

Examples of particularly suitable pigment derivatives I include the following: quinophthalone sulfonic acids of the formula Ia

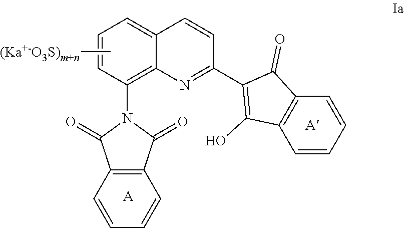

copper phthalocyanine sulfonic acids of the formula Ib

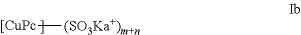

perylene sulfonic acids of the formula Ic

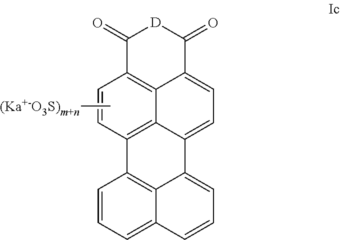

In these formulae the variables Ka⁺ and m+n have the definition given at the outset, with Ka preferably being Na⁺ or N⁺R²R³R⁴R⁵ (in particular with the preferred combinations of the radicals R² to R⁵ as set out above). In the case of the compounds Ia and Ic, the sum m+n is more particularly 1, and the sulfonic acid groups are preferably in position 6 in the compounds Ia and position 9 in the compounds Ic.

The rings A and A′ in formula Ia may be alike or different and may each be substituted by 1 to 4 chlorine and/or fluorine atoms. Preferably both rings carry 4 chlorine atoms.

The variable D is —O— or —NR⁹—, where R⁹ is hydrogen, C₁-C₄-alkyl or phenyl which may be substituted by C₁-C₄-alkyl, C₁-C₄-alkoxy and/or phenylazo. Preferably R⁹ is hydrogen, methyl, 4-ethoxyphenyl, 3,5-dimethylphenyl or 4-phenylazophenyl.

Especially preferred pigment derivatives Ia and Ib are those having the definitions of the variables indicated as being preferred, the pigment derivatives Ia taking the form, preferably, of sodium salts, and the pigment derivatives Ib being able to be present not only as sodium salts but also as ammonium salts.

Further organic pigment core structures include azo, diketopyrrolopyrrole, metal complexes, quinacridones, isoindoline, and isoindolinones.

The pigment derivatives I are known and can be prepared by known processes.

Besides component (A), the aqueous pigment composition of the invention comprises a component (B), which represents an anionic or nonionic surface-active additive component which is based on at least one phosphoric or phosphonic ester.

The component may comprise one or more of these esters.

The proportion, based on the total weight of the composition of component (B), is 0.1% to 30% by weight. Preferably the proportion is 5% to 20% by weight.

In this context it is particularly preferred for component (B) to comprise at least one phosphoric ester.

Water-soluble anionic/nonionic surface-active additives based on phosphoric or phosphonic esters result in particular from the reaction products of polyethers with phosphoric acid, phosphorus pentoxide or phosphonic acid. In these cases the polyethers are converted into the corresponding phosphoric monoesters, diesters or triesters, or corresponding phosphonic esters. The anionic esters are present preferably in the form of water-soluble salts, more particularly as alkali metal salts, especially sodium salts, and ammonium salts, but may also be used in the form of the free acids.

Preferred phosphates and phosphonates derive in particular from alkoxylated, especially ethoxylated, fatty alcohols and oxo-process alcohols, alkylphenols, fatty amines, fatty acids, and resin acids, and amines, including polyfunctional amines, such as hexamethylenediamine.

Anionic surface-active additives of this kind are known and are available commercially, for example, under the names Crodafos® (Croda), Rhodafac® (Rhodia), Maphos® (BASF), Texapon® (Cognis), Empicol® (Albright & Wilson), Matexil® (ICI), Soprophor® (Rhodia), and Lutensit® (BASF), Strodex (Dexter), Hostphat® (Clariant).

Furthermore, lecithins are with particular preference a constituent of component (B).

With particular preference component (B) comprises soya lecithin. Lecithins are phospholipids which are composed of fatty acids, glycerol, phosphoric acid, and choline. The fatty acids here may be saturated or unsaturated.

The aqueous pigment composition of the invention further comprises as component (C) a nonionic surface-active additive component based on at least one hydroxyl-containing acetylene or acetylene alkoxylate. Component (C) may comprise one or more of these surface-active additives.

The proportion of component (C) in the aqueous pigment composition of the invention, based on the total weight of the composition, is 0.1% to 10% by weight. Preferably this proportion is 0.1% to 5% by weight.

The hydroxyl-containing acetylene is an acetylene, preferably having 2 to 100 carbon atoms and at least one triple bond, which additionally carries at least one hydroxyl group. Besides acetylene itself it is also possible to use an acetylene alkoxylate. This acetylene alkoxylate derives from the hydroxyl-containing acetylene and additionally has one or more alkoxylate chains, which may be of various lengths and comprise various alkoxylates such as ethoxylates, propoxylates, butoxylates. Furthermore, the acetylene alkoxylate also comprises a hydroxyl group, which typically represent the terminal hydroxyl groups of the alkoxylate chains. Alternatively the hydroxyl group or groups may also be attached directly to the acetylene hydrocarbon chain.

Component (C) preferably comprises at least one acetylenediol/acetylene alkoxylate diol.

Such diol compounds are preferably the following, of the general formula (I).

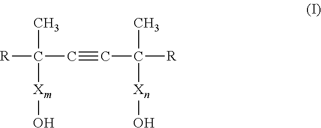

in which
each R independently is C₁-C₁₂-alkyl or alkylene radical, which may be branched or unbranched;
each X independently is selected from the group consisting of ethoxy, propoxy, and butoxy;
m+n is the number of moles of ethoxy, propoxy or butoxy groups and is situated in the range from 0 to 50.

Preferably each R independently is a branched or unbranched C₁-C₆ alkyl or alkylene radical and each X is preferably an ethoxy group and m+n is from 1 to 30, preferably from 10 to 30.

Additionally with preference m+n=0.

Particularly advantageous are acetylenediol derivatives of the following formula (II):

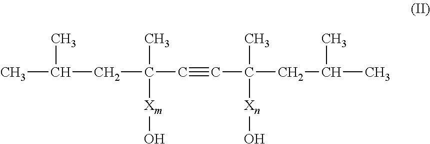

where
each X is selected from ethoxy, propoxy, and butoxy, preferably ethoxy radicals;
and m+n is situated in the range from 0 to 30, preferably from 10 to 30.

Exemplary compounds are preferred commercially available surface-active acetylene derivatives which are known under the brand name Surfynol (Air Products, Inc., Allentown, US). Examples thereof are Surfynol 104, which is identified as 2,4,7,9-tetramethyl-5-decyne-4,7-diol (in the above formula m+n=0). Solutions of these diols are available in various solvents and are sold under the brand names Surfynol 104A, Surfynol 104E, Surfynol 104H, and 104BC. Likewise conventional are mixtures of acetylenediols, which are likewise available from Air Products, such as Surfynol GA, SE, TG, and PC. Additionally it is possible to use Surfynol 61, which is described as dimethylhexynediol (R═CH₃), and also Surfynol 82, described as dimethyloctynediol (R═CH₂CH₃). In particular it is possible to use ethoxylated derivatives of tetramethyldecynediol which are available under the brand name Surfynol 440, Surfynol 465, Surfynol 485, and Surfynol 2502. Surfynol 465 in particular is described as a reaction product of about 10 mol of ethylene oxide (m+n=10) with one mole of tetramethyldecynediol. Surfynol 485 is described as a reaction product of about 30 mol of ethylene oxide, such that each X represents an ethoxy group and m+n=30, with one mole of tetramethyldecynediol.

Further ethoxylated acetylenediol derivatives are known from Air Products under the brand name Dynol (e.g., Dynol 604).

The aqueous pigment composition of the invention may further comprise an additive component (D) which comprises additives different from (B) and (C). The additive component may comprise one or more very different additives. The composition preferably comprises further surface-active additives different from (B) and (C).

The proportion of this additive component, when present, is up to 20% by weight, preferably 0.1% to 20% by weight. In particular the fraction is 0.1% to 10% by weight. The fractions of components (D) are based on the total weight of the composition. Component (D) may also not be present in the composition of the invention.

Such additives may, for example, be polyethers.

Particularly suitable nonionic additives are based on polyethers. These polyethers, described in more detail below, may also serve as starting compounds of the above-described additives (B).

As well as the unmixed polyalkylene oxides, preferably C₂-C₄-alkylene oxides and phenyl-substituted C₂-C₄-alkylene oxides, especially polyethylene oxides, polypropylene oxides, and poly(phenylethylene oxides), suitability here is possessed in particular by block copolymers, especially polymers containing polypropylene oxide blocks and polyethylene oxide blocks or poly(phenylethylene oxide) and polyethylene oxide blocks, and also random copolymers of these alkylene oxides.

These polyalkylene oxides can be prepared by polyaddition of the alkylene oxides onto starter molecules, such as saturated or unsaturated aliphatic and aromatic alcohols, saturated or unsaturated aliphatic and aromatic amines, saturated or unsaturated aliphatic carboxylic acids and carboxamides, and also aromatic carboxamides and sulfonamides. These aromatic starter molecules may be substituted by C₁-C₂₀-alkyl or C₇-C₃₀-aralkyl. It is customary to use 1 to 300 mol, preferably 3 to 150 mol, of alkylene oxide per mole of starter molecule; in the case of aromatic starter molecules, the amounts of alkylene oxide are especially 2 to 100 mol, preferably 5 to 50 mol, and in particular 10 to 30 mol. The polyaddition products may contain a terminal OH group or may be end group-capped, being present, for example, in the form of C₁-C₆-alkyl ethers.

Suitable aliphatic alcohols here comprise generally 6 to 26 C atoms, preferably 8 to 18 C atoms, and may be unbranched, branched or cyclic in construction. Examples include octanol, nonanol, decanol, isodecanol, undecanol, dodecanol, 2-butyloctanol, tridecanol, isotridecanol, tetradecanol, pentadecanol, hexadecanol (cetyl alcohol), 2-hexyldecanol, heptadecanol, octadecanol (stearyl alcohol), 2-heptylundecanol, 2-octyldecanol, 2-nonyltridecanol, 2-decyltetradecanol, oleyl alcohol, and 9-octadecenol, and also mixtures of these alcohols, such as C₈/C₁₀—, C₁₃/C₁₅—, and C₁₆/C₁₈ alcohols, and cyclopentanol and cyclohexanol. Of particular interest are the saturated and unsaturated fatty alcohols which are obtained by fat hydrolysis and reduction from natural raw materials, and the synthetic fatty alcohols from the oxo process. The alkylene oxide adducts with these alcohols typically have average molecular weights Mₙ of 200 to 5000.

Examples of aromatic alcohols, as well as unsubstituted phenol and α- and β-naphthol, also include the alkyl-substituted products, which are substituted in particular by C₁-C₁₂ alkyl, preferably C₄-C₁₂ or C₁-C₄ alkyl, and the aralkyl-substituted products, especially C₇-C₃₀ aralkyl-substituted phenol, such as hexylphenol, heptylphenol, octylphenol, nonylphenol, isononylphenol, undecylphenol, dodecylphenol, di- and tributylphenol, and dinonylphenol, and also bisphenol A and its reaction products with styrene, especially bisphenol A substituted by a total of 4 phenyl-1-ethyl radicals in the ortho positions with respect to the two OH groups.

Suitable aliphatic amines correspond to the aliphatic alcohols recited above. Again of particular importance here are the saturated and unsaturated fatty amines which have preferably 14 to 20 C atoms. Examples of aromatic amines include aniline and its derivatives.

Suitable aliphatic carboxylic acids are, in particular, saturated and unsaturated fatty acids, comprising preferably 14 to 20 C atoms, and hydrogenated, partially hydrogenated, and unhydrogenated resin acids, and also polybasic carboxylic acids, dicarboxylic acids for example, such as maleic acid.

Suitable carboxamides derive from these carboxylic acids.

Besides the alkylene oxide adducts with the monofunctional amines and alcohols, very particular interest attaches to the alkylene oxide adducts with at least difunctional amines and alcohols.

Preferred amines with a functionality of at least two are difunctional to pentafunctional amines which correspond in particular to the formula H₂N—(R¹—NR²)ₙ—H(R¹: C₂-C₆ alkylene; R²: hydrogen or C₁-C₆ alkyl; n: 1 to 5). Specific examples include the following: ethylenediamine, diethylenetriamine, triethylenetetramine, tetraethylenepentamine, propylene-1,3-diamine, dipropylenetriamine, 3-amino-1-ethylenaminopropane, hexamethylenediamine, dihexamethylenetriamine, 1,6-bis(3-aminopropylamino)hexane, and N-methyldipropylenetriamine, particular preference being given to hexamethylenediamine and diethylenetriamine, and especial preference to ethylenediamine.

Preferably these amines are reacted first with propylene oxide and then with ethylene oxide. The ethylene oxide content of the block copolymers is typically about 10% to 90% by weight.

The block copolymers based on polyfunctional amines generally have average molecular weights Mₙ of 1000 to 40 000, preferably 1500 to 30 000.

Preferred alcohols having a functionality of at least two are dihydric to pentahydric alcohols. Mention may be made, by way of example, of C₂-C₆ alkylene glycols and the corresponding di- and polyalkylene glycols, such as ethylene glycol, propylene 1,2-glycol and 1,3-glycol, butylene 1,2-glycol and 1,4-glycol, hexylene 1,6-glycol, dipropylene glycol, and polyethylene glycol, glycerol and pentaerythritol, particular preference being given to ethylene glycol and polyethylene glycol, and especial preference to propylene glycol and dipropylene glycol.

Particularly preferred alkylene oxide adducts with at least difunctional alcohols have a central polypropylene oxide block, in other words start from a propylene glycol or polypropylene glycol, which is reacted first with further propylene oxide and then with ethylene oxide. The ethylene oxide content of the block copolymers is typically 10% to 90% by weight.

The block copolymers based on polyhydric alcohols generally have average molecular weights Mₙ of 1000 to 20 000, preferably 1000 to 15 000.

Nonionic surface-active additives of this kind are known and are available commercially, as for example under the names Tetronic®, Pluronic®, and Pluriol®Lutensol (BASF), Atlas®, Symperonic (Uniqema), Emulgator WN and 386 (Lanxess), and also Rhodasurf, Soprophor® (Rhodia), Genopol (Clariant), Dowfax (Dow), Berol, Duomeen, Ethomeen (Akzo), Ethylan (Akcros).

Examples of further, particularly suitable water-soluble anionic surface-active agents present in component (D) include additives based on polymers of ethylenically unsaturated carboxylic acids, additives based on polyurethanes, and additives based on polycondensation products of aromatic sulfonic acids and formaldehyde.

It will be appreciated that mixtures of two or more additives may also be used in component (D), in other words not only mixtures of different nonionic additives but also mixtures of different anionic additives, and also mixtures of nonionic and anionic additives.

Especially suitable anionic water-soluble surface-active additives based on polymers of unsaturated carboxylic acids are additives from the group of the homopolymers and copolymers of ethylenically unsaturated monocarboxylic acids and/or ethylenically unsaturated dicarboxylic acids, which may additionally comprise, in copolymerized form, vinyl monomers comprising no acid function; the alkoxylation products of these homopolymers and copolymers; and the salts of these homopolymers and copolymers and their alkoxylation products.

Examples of the carboxyl-containing monomers and the vinyl monomers include the following:
acrylic acid, methacrylic acid, and crotonic acid;
maleic acid, maleic anhydride, maleic monoesters, maleic monoamides, reaction products of maleic acid with diamines, which may be oxidized to form derivatives containing amine oxide groups, and fumaric acid, preference being given to maleic acid, maleic anhydride, and maleic monoamides;
Vinylaromatics, such as styrene, methylstyrene, and vinyltoluene; ethylene, propylene, isobutene, diisobutene, and butadiene; vinyl ethers, such as polyethylene glycol monovinyl ether;
vinyl esters of linear or branched monocarboxylic acids, such as vinyl acetate and vinyl propionate; alkyl esters and aryl esters of ethylenically unsaturated monocarboxylic acids, especially acrylic esters and methacrylic esters, such as methyl, ethyl, propyl, isopropyl, butyl, pentyl, hexyl, 2-ethylhexyl, nonyl, lauryl, and hydroxyethyl (meth)acrylate and also phenyl, naphthyl, and benzyl (meth)acrylate; dialkyl esters of ethylenically unsaturated dicarboxylic acids, such as dimethyl, diethyl, dipropyl, diisopropyl, dibutyl, dipentyl, dihexyl, di-2-ethylhexyl, dinonyl, dilauryl, and di-2-hydroxyethyl maleate and fumarate; vinylpyrrolidone; acrylonitrile and methacrylonitrile, preference being given to styrene, isobutene, diisobutene, acrylic esters, and polyethylene glycol monovinyl ether.

Examples of preferred homopolymers of these monomers include, in particular, polyacrylic acids.

The copolymers of the stated monomers may be composed of two or more, in particular three, different monomers. They may be random copolymers, alternating copolymers, block copolymers, and graft copolymers. Preferred copolymers include styrene/acrylic acid, acrylic acid/maleic acid, acrylic acid/methacrylic acid, butadiene/acrylic acid, isobutene/maleic acid, diisobutene/maleic acid, and styrene/maleic acid copolymers, each of which may comprise acrylic esters and/or maleic esters as additional monomer constituents.

The carboxyl groups of the unalkoxylated homopolymers and copolymers are preferably at least partly in salt form, in order to ensure solubility in water. Suitable examples include the alkali metal salts, such as sodium salts and potassium salts, and the ammonium salts.

Typically the unalkoxylated polymeric additives have average molecular weights M_{w} of 900 to 250 000. The molecular weight ranges that are particularly suitable for the individual polymers depend, of course, on their composition. Below, molecular weight figures are given exemplarily for various polymers: polyacrylic acids: M_{w} from 900 to 250 000; styrene/acrylic acid copolymers: M_{w} from 1000 to 50 000; acrylic acid/methacrylic acid copolymers: M_{w} from 1000 to 250 000; acrylic acid/maleic acid copolymers: M_{w} from 2000 to 70 000.

Besides these homopolymers and copolymers themselves, their alkoxylation products are also of particular interest as additives.

These are, in particular, the polymers featuring partial to (as far as is possible) complete esterification with polyether alcohols. Generally speaking, the degree of esterification of these polymers is 30 to 80 mol %.

Suitability for the esterification is possessed in particular by alcohols such as ethanol, propanol, isopropanol, butanol, fatty alcohols, the polyether alcohols themselves, preferably polyethylene glycols and polypropylene glycols, and also their derivatives with endgroup capping at one end, especially the corresponding monoethers, such as monoaryl ethers, e.g., monophenyl ethers, and especially mono-C₁-C₂₆ alkyl ethers, examples being ethylene and propylene glycols that are etherified with fatty alcohols, and the polyetheramines, which are preparable, for example, by converting a terminal OH group of the corresponding polyether alcohols or by polyaddition of alkylene oxides with preferably primary aliphatic amines. Preference is given here to polyethylene glycols, polyethylene glycol monoethers, and polyetheramines. The average molecular weights Mₙ of the polyether alcohols and their derivatives that are used are situated typically at 200 to 10 000.

By controlling the ratio of polar to apolar groups it is possible to tailor the surface-active properties of the additives.

Anionic surface-active additives of this kind are likewise known and are available commercially, for example, under the names Sokalan® (BASF), Joncryl® (Johnson Polymer), Alcosperse® (Alco), Geropon® (Rhodia), Good-Rite® (Goodrich), Neoresin®(Avecia), Orotan® and Morez® (Rohm & Haas), Disperbyk® (Byk), and Tegospers® (Degussa).

As anionic surface-active additives polyurethane-based additives may additionally be present in component (D).

The term “polyurethane” as used herein embraces not only the pure reaction products of polyfunctional isocyanates with organic compounds comprising isocyanate-reactive hydroxyl groups, but also those reaction products which are additionally functionalized by virtue of the addition of further isocyanate-reactive compounds, such as of carboxylic acids carrying primary or secondary amino groups, for example.

These additives are notable over other surface-active additives for their low ion conductivity and their neutral pH.

Especially suitable polyfunctional isocyanates for preparing these additives are diisocyanates, though it is also possible to use compounds having three or four isocyanate groups. Both aromatic and aliphatic isocyanates can be used.

Examples of preferred di- and triisocyanates include the following: 2,4-tolylene diisocyanate (2,4-TDI), 4,4′-diphenylmethane diisocyanate (4,4′-MDI), para-xylylene diisocyanate, 1,4-diisocyanatobenzene, tetramethylxylylene diisocyanate (TMXDI), 2,4′-diphenylmethane diisocyanate (2,4′-MDI), and triisocyanatotoluene, and also isophorone diisocyanate (IPDI), 2-butyl-2-ethylpentamethylene diisocyanate, tetramethylene diisocyanate, hexamethylene diisocyanate, dodecamethylene diisocyanate, 2,2-bis(4-isocyanatocyclohexyl)propane, trimethylhexane diisocyanate, 2-isocyanatopropylcyclohexyl isocyanate, 2,4,4- and 2,2,4-trimethylhexamethylene diisocyanate, 2,4′-methylenebis(cyclohexyl)diisocyanate, cis-cyclohexane 1,4-diisocyanate, trans-cyclohexane 1,4-diisocyanate, and 4-methylcyclohexane 1,3-diisocyanate (H-TDI).

It will be appreciated that mixtures of isocyanates can also be used. By way of example the following may be mentioned here: mixtures of structural isomers of 2,4-toluoylene diisocyanate and triisocyanatotoluene, e.g., mixtures of 80 mol % 2,4-toluoylene diisocyanate and 20 mol % 2,6-tolylene diisocyanate; mixtures of cis- and trans-cyclohexane 1,4-diisocyanate; mixtures of 2,4- or 2,6-toluoylene diisocyanate with aliphatic diisocyanates, such as hexamethylene diisocyanate and isophorone diisocyanate.

Suitable isocyanate-reactive organic compounds include, preferably, compounds having at least two isocyanate-reactive hydroxyl groups per molecule. Suitable compounds, however, are also compounds which have only one isocyanate-reactive hydroxyl group per molecule. These monofunctionalized compounds may partly or even wholly replace the compounds comprising at least two isocyanate-reactive hydroxyl groups per molecule in the reaction with the polyisocyanate.

Listed below are examples of particularly preferred isocyanate-reactive compounds having at least two isocyanate-reactive hydroxyl groups per molecule.

These are polyetherdiols, polyesterdiols, lactone-based polyesterdiols, diols and triols having up to 12 C atoms, dihydroxycarboxylic acids, dihydroxysulfonic acids, dihydroxyphosphonic acids, polycarbonatediols, polyhydroxyolefins, and polysiloxanes having on average at least two hydroxyl groups per molecule.

Suitable polyetherdiols are, for example, homopolymers and copolymers of C₂-C₄ alkylene oxides, such as ethylene oxide, propylene oxide, and butylene oxide, tetrahydrofuran, styrene oxide and/or epichlorohydrin, which are obtainable in the presence of a suitable catalyst, boron trifluoride for example. Additionally suitable polyetherdiols are obtainable by (co)polymerization of these compounds in the presence of a starter having at least two acidic hydrogen atoms, e.g., of water, ethylene glycol, thioglycol, mercaptoethanol, 1,3-propanediol, 1,4-butanediol, 1,6-hexanediol, 1,12-dodecanediol, ethylenediamine, aniline or 1,2-di-(4-hydroxyphenyl)propane.

Examples of particularly suitable polyetherdiols are polyethylene glycol, polypropylene glycol, polybutylene glycol, and polytetrahydrofuran, and also copolymers thereof.

The molecular weight Mₙ of the polyetherdiols is preferably 250 to 5000, more preferably 500 to 2500.

Polyesterdiols (hydroxypolyesters) with suitability as an isocyanate-reactive compound are common knowledge.

Preferred polyesterdiols are the reaction products of diols with dicarboxylic acids or their reactive derivatives, such as anhydrides or dimethyl esters, for example.

Suitable dicarboxylic acids are saturated and unsaturated, aliphatic and aromatic dicarboxylic acids, which may carry additional substituents, such as halogen. Preferred aliphatic dicarboxylic acids are saturated and branched α,ω-dicarboxylic acids which comprise 3 to 22, especially 4 to 12, C atoms.

Examples of particularly suitable dicarboxylic acids are as follows: succinic acid, glutaric acid, adipic acid, suberic acid, azelaic acid, sebacic acid, 1,12-dodecanedicarboxylic acid, maleic acid, maleic anhydride, fumaric acid, itaconic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, terephthalic acid, dimethyl terephthalate, and dimethyl isophthalate.

Suitable diols include, in particular, saturated and unsaturated aliphatic and cycloaliphatic diols. The particularly preferred aliphatic α,ω-diols are unbranched and have 2 to 12, more particularly 2 to 8, especially 2 to 4, C atoms. Preferred cycloaliphatic diols derive from cyclohexane.

Examples of particularly suitable diols are as follows: ethylene glycol, propylene glycol, 1,3-propanediol, 1,4-butanediol, 2-methylpropane-1,3-diol, 1,5-pentanediol, neopentyl glycol, 1,6-hexanediol, 1,8-octanediol, 1,10-decanediol, 1,12-dodecanediol, cis- and trans-but-2-ene-1,4-diol, 2-butyne-1,4-diol, and cis- and trans-1,4-di-(hydroxymethyl)cyclohexane.

The molecular weight Mₙ of the polyesterdiols is preferably 300 to 5000.

Lactone-based polyesterdiols with suitability as isocyanate-reactive compound are based in particular on aliphatic saturated unbranched ω-hydroxycarboxylic acids having 4 to 22, preferably 4 to 8, C atoms. Also suitable are branched ω-hydroxycarboxylic acids in which one or more —CH₂— groups in the alkylene chain have been replaced by —CH(C₁-C₄ alkyl)-.

Examples of preferred ω-hydroxycarboxylic acids are y-hydroxybutyric acid and δ-hydroxyvaleric acid.

Also suitable, of course, are the abovementioned diols as isocyanate-reactive compounds, subject to the same preferences as above.

Likewise suitable as isocyanate-reactive compounds are triols, containing in particular 3 to 12, especially 3 to 8, C atoms. An example of a particularly suitable triol is trimethylolpropane.

Dihydroxycarboxylic acids with particular isocyanate-reactive compound suitability are, in particular, aliphatic saturated dihydroxycarboxylic acids comprising preferably 4 to 14 C atoms. Especially suitable are dihydroxycarboxylic acids of the formula

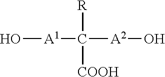

in which A¹ and A² are like or different C₁-C₄ alkylene radicals and R is hydrogen or C₁-C₄ alkyl.

A particularly preferred example of these dihydroxycarboxylic acids is dimethyloipropionic acid (DMPA).

Additionally suitable as isocyanate-reactive compounds are the corresponding dihydroxysulfonic acids and dihydroxyphosphonic acids, such as 2,3-dihydroxypropanephosphonic acid.

The term “dihydroxycarboxylic acids” as used herein is also intended to encompass compounds which comprise more than one carboxyl function (and/or anhydride or ester function). Such compounds are obtainable by polyaddition reaction of dihydroxy compounds with tetracarboxylic dianhydrides, such as pyromellitic dianhydride or cyclopentanetetracarboxylic dianhydride, in a molar ratio of 2:1 to 1.05:1, and preferably have an average molecular weight Mₙ of 500 to 10 000.

Examples of suitable polycarbonatediols include the reaction products of phosgene with an excess of diols, especially unbranched saturated aliphatic am-diols having 2 to 12, especially 2 to 8, in particular 2 to 4 C atoms.

Polyhydroxyolefins with isocyanate-reactive compound suitability are, in particular, ω,ω-dihydroxyolefins, with α,ω-dihydroxybutadienes being preferred.

The polysiloxanes that are additionally suitable as isocyanate-reactive compound comprise on average at least two hydroxyl groups per molecule. Particularly suitable polysiloxanes have on average 5 to 200 Si atoms (numerical average) and are substituted in particular by C₁-C₁₂ alkyl groups, especially methyl groups.

Examples of isocyanate-reactive compounds which contain only one isocyanate-reactive hydroxyl group include, in particular, aliphatic, cycloaliphatic, araliphatic or aromatic monohydroxy-carboxylic and -sulfonic acids.

Besides the abovementioned isocyanate-reactive compounds it is possible to add further compounds with isocyanate-reactive groups, examples being dithiols, thioalcohols, such as thioethanol, aminoalcohols, such as ethanolamine and N-methylethanolamine, or diamines, such as ethylenediamine, and so to prepare polyurethanes which as well as the urethane groups also carry isocyanurate groups, allophanate groups, urea groups, biuret groups, uretdione groups or carbodiimide groups. Further examples of such isocyanate-reactive compounds are aliphatic, cycloaliphatic, araliphatic or aromatic carboxylic acids and sulfonic acids which carry at least two primary and/or secondary amino groups.

It is of course also possible to add corresponding compounds containing only one isocyanate-reactive group, examples being monoalcohols, primary and secondary monoamines, monoaminocarboxylic and monoaminosulfonic acids, and mercaptans.

The carboxyl groups of the reaction products are preferably at least partly in salt form in order to ensure solubility in water. Suitable examples include alkali metal salts, such as sodium and potassium salts, and ammonium salts.

The additives typically have average molecular weights M_{w} of 500 to 250 000.

By controlling the ratio of polar to apolar groups it is possible to tailor the surface-active properties of the additives.

Anionic surface-active additives of these kinds are known and are available commercially, for example, under the name Borchi® GEN SN95 (Borchers).

It is also possible, furthermore, for other additives to be present.

In addition there may also be a small amount of defoamers (preferably 0.01% to 0.2% by weight, where present, based on the total weight of the composition, from the companies Tego, Byk, Borchers, for example) and biocides (preferably 0.01% to 0.5% by weight, where present, based on the total weight of the composition, from the companies Thor, Rohm & Haas, for example) in the component. Additionally it is possible to use thickeners as well (preferably 0.01% to 2% by weight, where present, based on the total weight of the composition, from—for example—the companies Coatex, BASF, Tego, Aqualon).

The aqueous pigment composition of the invention further comprises a solvent component (E), which comprises at least water. The solvent component may be composed of further solvents, it being preferred for these solvents to be at least partly miscible with water in the composition of the invention.

The proportion of component (E) in the aqueous pigment composition of the invention, based on the total weight of the composition, is 1% to 89.8% by weight. The proportion of component (E) is preferably 10% to 89.8% by weight.

Examples of further solvents are, in particular, alcohols, diols, triols and also polyols, which may be partly alkoxylated. Examples of such 2-ethylhexanol, 2-butoxyethanol, dipropylene glycol monomethyl ether, ethylene glycol, n-propyl alcohol, isopropyl alcohol, propylene glycol, and butylene glycol. Deserving a particular mention are diethylene glycol, dipropylene glycol, and dibutylene glycol, polyethylene glycols having a molecular weight of 200-1000 g/mol, and also Texanol and Texanol ester alcohols, it being possible for these solvents to be used simultaneously as film binders (coalescers) and as water retention agents. In the context of the present invention, however, these substances are considered part of the solvent component.

The aqueous pigment composition of the invention that can be used universally is preferably in a pasty form.

Its pigment content is therefore 10% to 70% by weight, based on the total weight of the composition of the invention.

Additionally it is preferred for the inventively aqueous pigment composition to be flowable and pumpable.

The present invention further provides a process for preparing a composition of the invention, comprising the steps of
(a) combining component (A) and, if appropriate, at least some of components (B) to (D) in at least one part of component (E);
(b) wet-comminuting the resulting suspension; and
(c) if appropriate, adding components (B) to (D) and/or the rest of components (B) to (E).

In this process it is particularly preferred to add component (C) completely not until step (c).

The aqueous pigment composition of the invention can be used to pigment liquid systems.

These liquid systems are preferably paint products, varnishes, emulsion paints, and printing inks. Preference is given here to water-based emulsion paints, especially based on styrene/acrylate; alkyd-melamine baking varnishes; alkyd varnishes, especially low-aromatics-content and/or air-drying varnishes, acrylate-isocyanate varnishes; protective alkyd resin wood stains; in particular, low-aromatics-content stains and protective aqueous polyurethane/acrylate wood stains.

### EXAMPLES

### Example 1

### Inventive Compositions

Compositions ZS-1 to ZS-5, with the constituents indicated in the table (in % by weight), are prepared by a conventional method.

| Chemical nature of | | | | | | Trade name/brief |
|---|---|---|---|---|---|---|
| component | ZS-1 | ZS-2 | ZS-3 | ZS-4 | ZS-5 | description |
| Transparent iron oxide (A) | 34.50 | | | | | Sicotrans Red L 2817 |
| Transparent iron oxide (A) | | 34.50 | | | | Sicotrans Yellow L 1916 |
| P.BI. 7 | | | 20.0 | | | Carbon black |
| P.B. 15:3 | | | | 30.0 | | Heliogen Blue L 7080 |
| P.Y. 74 | | | | | 30.0 | Sicoecht Yellow 1252 |
| Triethylene glycol (E) | 5.00 | 5.00 | 5.0 | 5.0 | 5.0 | TEG |
| Alkyl alkylene oxide | 11.00 | 10.2 | 7.5 | 7.5 | 7.5 | |
| phosphate ester (B) | | | | | | |
| Acetylenediol (C) | 3.00 | 2.00 | 0.5 | 0.5 | 0.5 | Surfynol 104 |
| Lecithin hydrophobic (B) | 7.50 | 5.00 | 5.0 | 5.0 | 5.0 | Soya Lecithin |
| Water (E) | 38.50 | 42.8 | 62.0 | 52 | 52 | Fully demineralized water |
| Pigment synergist (A) | 0.50 | 0.50 | 0 | 0 | 0 | Quinophthalonesulfonic |
| | | | | | | acid Ia |
| | 100 | 100 | 100 | 100 | 100 | |

### Example 2

### Assessment of the Coloristic Properties and Viscosity of the Inventive Compositions (Pastes)

The following paints are tested:
1. Water-based emulsion paint based on styrene/acrylate bases with a white pigment content of 16.4% by weight (TiO₂, Kronos 2043) (test binder 00-1067, BASF).
2. Alkyd-melamine baking varnish (56% by weight solids fraction, xylene/butanol as solvents).
   White reduction with white pigment content of 27.0% by weight (TiO₂, Kronos 2059) 40% binder (test binder EL 2, BASF).
3. Alkyd-melamine baking varnish (35% by weight solids content, xylene as solvent).
   White reduction with white pigment content of 20.0% by weight (TiO₂, Kronos 2059) (test binder EPL, BASF)
4. Commercial low-aromatics-content, air-drying alkyd varnish (Akzo, Rubbol).
   Low-aromatics-content alkyd varnishes comprise predominantly aliphatic hydrocarbons (hydrogenated naphtha, paraffin) and only small fractions of aromatic solvents (<5% in paint).
5. Air-drying alkyd varnish (45% by weight solids content, xylene as solvent, BASF test varnish AF 485).
   White reduction with white pigment content of 25.6% TiO₂ Kronos 2059.
6. Acrylate-isocyanate varnish (2-component) (40% by weight solids content with xylene/methoxypropyl acetate as solvents).
   White reduction with 21% TiO₂ content.
7. Commercial air-drying, low-aromatics-content protective alkyd resin wood stain
   Solvents: isoparaffins, hydrogenated naphtha.

### Testing:

In a 150 ml plastic beaker a mixture of 3.5 g of pigment paste and 50 g of paint (colored varnish for mass tone assessment or white varnish for color strength assessment) is homogenized using a high-speed stirrer at 1500 rpm for 3 minutes. The resulting paint is then drawn down with a 150 μm spiral-wound doctor onto black/white test card, and dried for 30 minutes. The baking varnishes (EPL, EL2) are additionally baked in a drying cabinet at 130° C. for 30 minutes.

The parameters tested are the color strength in the white reduction (statement of the coloring equivalents FAE, DIN 55986), the mass tone transparency, and the number of gel specks.

The pigment pastes of the invention can be dispersed in the individual paints without rub-out and with no gel specks. The color strength is comparable with that of the corresponding aqueous and solventborne pastes respectively.

The storage stability is tested by storing the pastes in a drying cabinet at 50° C. for 7 days.

For all of the inventive pastes ZS-1 to ZS-5 there are no significant changes in viscosity. Consequently they can be used universally for aqueous and organic (both aliphatic and aromatic) systems.

1. An aqueous pigment composition comprising, based in each case on a total weight of the composition:
(A) 10% to 70% by weight of a coloring component comprising at least one color pigment and optionally at least one filler;
(B) 0.1% to 30% by weight of a surface-active additive component comprising at least one phosphoric or phosphonic ester, which may be anionic or nonionic;
(C) 0.1% to 10% by weight of a nonionic, surface-active additive component comprising at least one hydroxyl-containing acetylene or acetylene alkoxylate;
(D) 0% to 20% by weight of an additive component comprising at least one additive different than (B) and (C);
(E) 1% to 89.8% by weight of a solvent component at least comprising water.

2. The composition according to claim 1, wherein the coloring component (A) comprises a pigment synergist.

3. The composition according to claim 1, wherein the coloring component (A) comprises at least one inorganic pigment.

4. The composition according to claim 1, wherein the surface-active additive component (B) comprises at least one phosphoric ester.

5. The composition according to claim 1, wherein the nonionic, surface-active additive component (C) comprises at least one selected from the group consisting of an acetylenediol and an acetylene alkoxylate diol.

6. The composition according to claim 1, wherein the additive component (D) comprises at least one further surface-active additive different than (B) and (C).

7. The composition of claim 1, in the form of a paste.

8. A process for preparing a composition according to claim 1, comprising;
(a) combining the coloring component (A) and, optionally, at least some of components (B) to (D), in at least one part of the solvent component (E), to give a resulting suspension;
(b) wet-comminuting the resulting suspension; and
(c) optionally, adding components (B) to (D) and/or the rest of components (B) to (E).

9. The process according to claim 8, wherein the nonionic, surface-active additive component (C) is not added until (c).

10. A method of pigmenting a liquid system, the method comprising combining the composition according to claim 1 with the liquid system.

11. The composition according to claim 2, wherein the coloring component (A) comprises at least one inorganic pigment.

12. The composition according to claim 2, wherein the surface-active additive component (B) comprises at least one phosphoric ester.

13. The composition according to claim 3, wherein the surface-active additive component (B) comprises at least one phosphoric ester.

14. The composition according to claim 11, wherein the surface-active additive component (B) comprises at least one phosphoric ester.

15. The composition according to claim 2, wherein the nonionic, surface-active additive component (C) comprises at least one selected from the group consisting of an acetylenediol and an acetylene alkoxylate diol.

16. The composition according to claim 3, wherein the nonionic, surface-active additive component (C) comprises at least one selected from the group consisting of an acetylenediol and an acetylene alkoxylate diol.

17. The composition according to claim 4, wherein the nonionic, surface-active additive component (C) comprises at least one selected from the group consisting of an acetylenediol and an acetylene alkoxylate diol.

18. The composition according to claim 11, wherein the nonionic, surface-active additive component (C) comprises at least one selected from the group consisting of an acetylenediol and an acetylene alkoxylate diol.

19. The composition according to claim 12, wherein the nonionic, surface-active additive component (C) comprises at least one selected from the group consisting of an acetylenediol and an acetylene alkoxylate diol.

20. The composition according to claim 13, wherein the nonionic, surface-active additive component (C) comprises at least one selected from the group consisting of an acetylenediol and an acetylene alkoxylate diol.
